(19) United States
(12) Patent Application Publication
(10) Pub. No.: US 2008/0250412 A1
(43) Pub. Date: Oct. 9, 2008

(54) Cooperative process-wide synchronization

(76) Inventors: Elizabeth An-Li Clark, Los Gatos, CA (US); Hari Ganapathy, San Jose, CA (US); Harshadrai Parekh, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/784,325

(22) Filed: Apr. 6, 2007

(51) Int. Cl. G06F 9/46

(52) U.S. Cl. 718/102

(57) ABSTRACT

One embodiment relates to a computer-implemented method of concurrently performing a process-wide operation in a multi-threaded process being executed on a computer system so as to result in more efficient performance of the computer system. A plurality of threads of the process concurrently participate in the process-wide operation. Finishing steps of the process-wide operation are performed by a last thread participating in the process-wide operation, regardless of whether the last thread is an initiator thread or a target thread. Other embodiments, aspects, and features are also disclosed.

### BACKGROUND OF THE INVENTION

1. Field of the Invention

The present invention relates generally to computer systems and software.

2. Description of the Background Art

A process may be defined as a virtual address space containing one or more threads. In other words, the process holds the address space and shared resources for all of the threads of a program.

A thread, composed of a context and a sequence of instructions to execute, may be defined as an independent flow of control within a process. The context may comprise, a local thread stack, a register set and a program counter.

### BRIEF DESCRIPTION OF THE DRAWINGS

FIG. 1A is a schematic diagram depicting a multi-threaded process.

FIG. 1B is a schematic diagram depicting an initiator thread and target threads within a process in accordance with an embodiment of the invention.

FIG. 2 is a flow chart depicting a procedure performed by a process upon initiation of a process-wide operation in accordance with an embodiment of the invention.

FIG. 3 is a flow chart depicting a procedure performed by an initiator thread of a process-wide operation in accordance with an embodiment of the invention.

FIG. 4 is a flow chart depicting a procedure performed by a target thread in accordance with an embodiment of the invention.

FIG. 5 is a schematic diagram of an example computer system.

### DETAILED DESCRIPTION

### Process-Wide Operations

Process-wide operations are operations, such as fork( ) or exit( ), that are initiated by one thread in a process but that involve all of the threads of that process. For example, in both fork and exit, all the threads in the process (except the initiator of the operation) must be quiesced before the operation can complete. In the case of fork, the rest of the threads are suspended. This is necessary for duplicating the process' address space and copying other data structures. For exit, the threads are halted and told to terminate themselves so there is only one thread left in the process. That thread then completes the exit.

Accordingly, some process-wide operations require synchronization and cooperation among multiple threads in a process. Examples of these operations are process-wide job control stop, process deactivation, and process-wide suspension. For these operations, until all threads in the process perform the operation or enter into a certain designated state, the operation is incomplete. Furthermore, although one thread in the process initiates the process-wide operation, any thread in the process is capable of detecting that all threads are done and performing finishing steps.

A prior implementation of process-wide operations relied on a process lock to be held for the entire duration of the process-wide operation. A process lock is a spin lock. Hence, if another process attempts to acquire the process lock and it is unavailable, that other process will keep trying (spinning) until it can acquire the lock.

Holding a process lock disadvantageously serializes activity among the threads of the process, preventing the threads from changing state and taking actions, such as exiting the process. It also created undesirable contention on the process lock which is required for many other process related activities.

### Per Thread List Lock and Concurrency Problems

The use of a per thread list lock reduces the dependency on the process lock by removing the need to hold the process lock for the entire duration of a process-wide operation. As such, the per thread list lock allows multiple threads in the process to execute concurrently and perform state changes.

Unfortunately, the per thread list lock also introduces concurrency issues as threads can be simultaneously executing and changing states. Hence, with a per thread list lock, it can be difficult and problematic to determine how many threads are still involved in the process-wide operation, and when they have all completed their transition to the new state.

An example of such a concurrency problem is when a thread which initiates a process-wide operation (i.e. the initiator thread) is performing an action on another thread (i.e. a target thread). Meanwhile, at the same time, the target thread itself notices that the process-wide operation has started and therefore attempts to perform the same action. In accordance with an embodiment of the invention, such a concurrency problem is overcome.

### Cooperative Process-Wide Synchronization Using Sequence Numbers

The present disclosure provides a novel method for determining when a process-wide operation is complete in an environment having a per thread list lock. The disclosed technique uses sequence numbers so as to determine when all live threads in the process have completed their transition to the new state, such that it can be determined when the process-wide operation is complete.

Advantageously, the use of sequence numbers allows concurrent execution among threads in the process during the process-wide operation. In addition, lock hold times are minimized, and the operation is enabled to complete in a shorter amount of time.

A synchronization sequence number is a monotonically increasing number which may be used at both the process and thread levels. When a process starts a process-wide operation, it is required to acquire a lock which may be referred to as a “process-wide operation” lock. At that time, the process is also assigned a process sequence number which is incremented by one for this new operation.

As the list of threads in the process is traversed by the initiator thread, the state of each target thread is considered to determine if it is ready for the process-wide operation.

If the target thread is ready for the operation, then its thread sequence number is compared with the process sequence number. If the sequence numbers are the same, then this indicates that the thread has already participated in the operation and should be skipped. On the other hand, if the sequence numbers are different, then this indicates that the thread has not yet participated in the operation. In the latter case, the thread does so participate in the operation, and thereafter copies the process sequence number to its thread sequence number. This prevents the thread from performing the operation twice. Additionally, the count of threads who have participated in the operation is kept in a “synchronization thread count” field which is incremented at this point (due to the thread having participated in the operation).

If the target thread is not in a state ready to participate in the process-wide operation, then the initiator of the operation leaves the thread alone and allows the thread itself to perform the transition. The thread may then do the same comparison of sequence numbers (comparing its thread sequence number with the process sequence number) before proceeding with the operation.

In accordance with one aspect of the invention, both the initiator thread of the process-wide operation and also the target threads will query to determine if the process-wide operation is complete. As described above, this may be done by comparing the count of threads which have synchronized with the count of live threads in the process to see if they are equal. If they are equal, then the process-wide operation is complete. (Note that it is possible for threads to exit the process while the operation is ongoing, in which case the live thread count will be decremented.) If the process-wide operation is complete, then the thread (either the initiator or one of the targets) which determines the process-wide operation is complete goes on to perform the finishing steps and then release the process-wide operation lock.

In accordance with another aspect of the invention, a mechanism is provided to prevent more than one thread from attempting to end the process-wide operation. This mechanism is as follows.

Regarding target threads, after performing the action of the operation, a target thread only needs to check the synchronized thread count against the live thread count to determine if it should end the process-wide operation. This is because, after performing the action, the target thread increments the synchronized thread count and so should be the first to notice if the synchronized thread count is equal to the live thread count. Therefore, there should be no ambiguity if one of the target threads decides to finish the process-wide operation.

Regarding the initiator thread, the initiator thread needs to determine if one of the target threads has already finished the operation, or if the operation is yet to be finished. Hence, in accordance with an embodiment of the invention, the initiator saves a copy of the process sequence number from the process structure when it first starts the process-wide operation. After the initiator thread has traversed all the threads in the process, it compares the saved value with the current process sequence number and a process-wide operation type field in the process structure. In a first case, if the operation is not yet finished, then the current sequence number should match the saved sequence number, and further the operation type should be the same type that it had when the operation was started. In a second case, if the operation is finished and there has been no subsequent process-wide operation, then the current and saved sequence numbers should still match, but the process type should be set to “NONE”. Finally, in a third case, if the operation is finished and there has been a subsequent process-wide operation, then the process sequence number would have been incremented (such that the current and saved sequence numbers do not match) and the process type should be a value other than “NONE”. Only in the first case does the initiator thread need to end the process-wide operation, provided that the count of threads which have synchronized is the expected target count

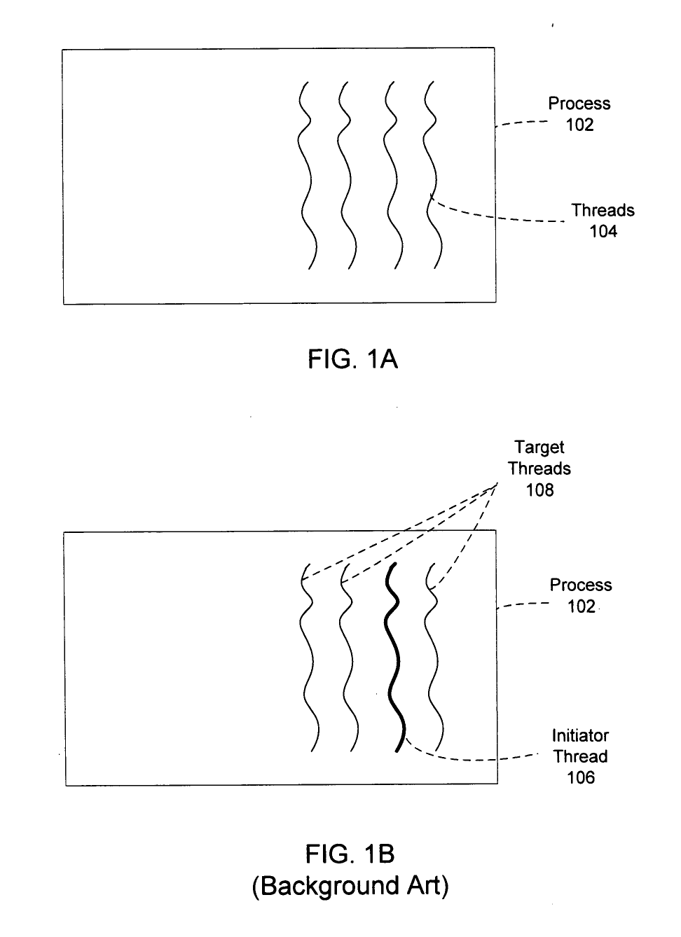

FIG. 1A is a schematic diagram depicting a multi-threaded process 102. As shown, such a process 102 includes a plurality of “live” threads 104. In this specific example four threads 104 are illustrated, but the number of threads may be more or less than that number. Furthermore, the number of threads may change over time as some threads 104 may exit the process 102, and new threads 104 may be created in the process 102.

FIG. 1B is a schematic diagram depicting an initiator thread 106 and target threads 108 within a process 102 in accordance with an embodiment of the invention. As used in this disclosure, the initiator thread 106 is the thread which initiates a process-wide operation, and the target (or non-initiator) thread(s) 108 are the other live threads of the same process 102.

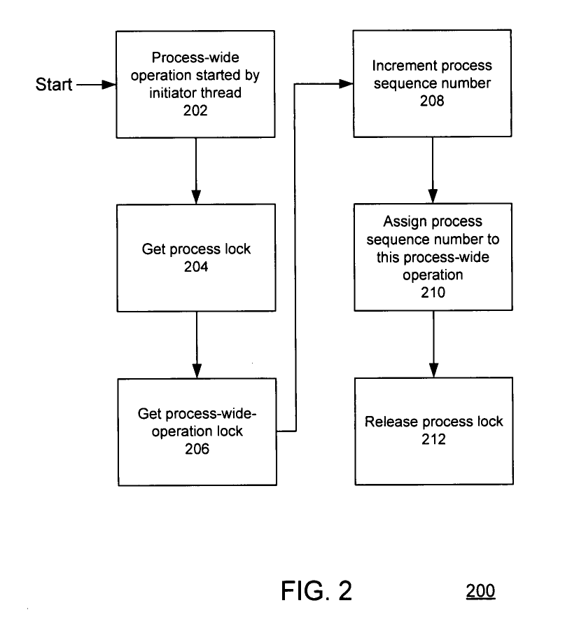

FIG. 2 is a flow chart depicting a procedure 200 performed by a process upon initiation of a process-wide operation in accordance with an embodiment of the invention. Per block 202, a process-wide operation is started by a thread (the “initiator” thread) within the process.

Per block 204, a process lock is acquired. The process lock is a spin lock which causes any other waiters on the lock to spin in a tight loop while waiting for the lock. Holding the process lock restricts other concurrent changes in the process, such as thread creation, thread exit, or priority changes. In accordance with an embodiment of the invention, the process lock is no longer required for the duration of the entire traversal of the threads in the process, but only while each thread is visited. As such, the process lock may be acquired and held long enough so as to get a “process-wide operation” lock (see block 206) and a “process sequence number” (see block 210), then the process lock may be released.

Per block 206, the “process-wide operation” lock is acquired. Unlike the process lock, the process-wide operation lock is a non-spin lock and does not cause threads waiting on it to spin in a tight loop. The process-wide operation lock is not always a blocking lock (caller sleeps while waiting). Hence, the process-wide operation will not stop potential progress of the target threads except to prevent starting any other process wide operations. In other words, the process wide operation lock cannot be acquired or released unless the caller gets process lock first.

After the locks are acquired, the “process sequence number” is incremented (block 208), and then assigned (block 210) to this process-wide operation. The process sequence number is a monotonically increasing number which is used for synchronization purposes as described further below. In addition, the operation which is taking place (for example, suspend, fork, etc.) is recorded. Thereafter, the process lock may be released (block 212), while the process-wide operation lock remains in place.

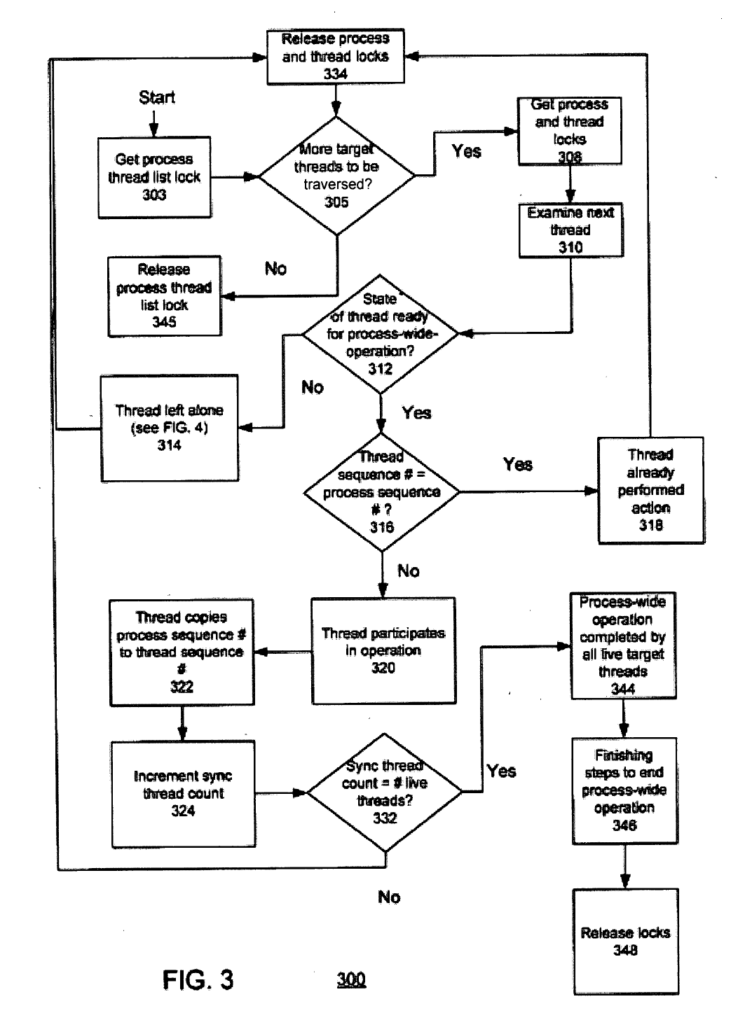

FIG. 3 is a flow chart depicting a procedure 300 performed by an initiator thread 106 of a process-wide operation in accordance with an embodiment of the invention.

In accordance with an embodiment of the invention, the initiator thread may begin the procedure by getting a “process thread list lock” (a novel blocking lock) (block 303). The process thread list lock protects the traversal of the threads in the process thread list and may be implemented as a non-spin lock. The process thread list lock keeps the thread list from changing (no threads can enter or leave the list) while the lock is held. Threads can exit, but they will stay on the list and be “zombies” until this process thread list lock can be acquired. The process thread list lock is to be held for the entire duration of the traversal of the threads in the process thread list. The process thread list lock is dropped (block 345) when the traversal is complete, whether all the threads are done with the process-wide operation or not.

A determination (block 305) is made as to whether there are more threads to be traversed. While there are more target threads to be traversed, the procedure gets the process and thread locks (block 308) and then “examines” (block 310) the next live target thread. A determination (block 312) is then made as to whether the state of the target thread is ready for the operation.

If the target thread is not ready to perform the operation, then the target thread is left alone (block 314) such that the target thread may continue to execute its sequence of instructions. Thereafter, the initiator thread may loop back by releasing process and thread locks (block 334) and then determining (block 305) whether any more target threads are to be traversed. Releasing the process lock advantageously allows the lock to be obtained by another caller if needed. Under a prior technique, the process lock would be held for the entire process-wide operation (until all the threads completed the operation). In other words, the technique disclosed herein advantageously shortens the hold times of the process lock.

If the target thread is ready to perform the operation, then the initiator thread checks (block 316) to see whether the “thread sequence number” is equal to the “process sequence number”.

If those sequence numbers are equal, then that means that this target thread has already performed the action for this operation (block 318). Hence, the procedure 300 loops back by releasing process and thread locks (block 334) and then determining (block 305) whether any more target threads are to be traversed.

On the other hand, if those sequence numbers are not equal, then that means that this target thread has not yet performed the action for this operation, so the target thread may go on to participate (block 320) in the operation. After that, the target thread copies (block 322) the process sequence number to its thread sequence number. The “sync thread count” is then incremented (block 324). As mentioned above, the sync thread count indicates the number of threads that have been synchronized; in other words, it indicates the number of threads that have already participated in the process-wide operation. Thereafter, the procedure 300 may check (block 332) whether a “sync thread count” is equal to a number of live threads in the process. The sync thread count is a count of a number of threads which have completed the process-wide operation.

If the sync thread count does not equal the number of live threads, then the procedure 300 may loop back by releasing process and thread locks (block 334) and then determining (block 305) whether any more target threads are to be traversed.

If the sync thread count equals the number of live threads, then the process-wide operation is deemed (block 344) to have been completed by all the live target threads, so that the initiator thread may perform appropriate finishing steps (block 346) to end the process-wide operation. Thereafter, the initiator thread may release (block 348) the various locks, including the process and process-wide operation locks.

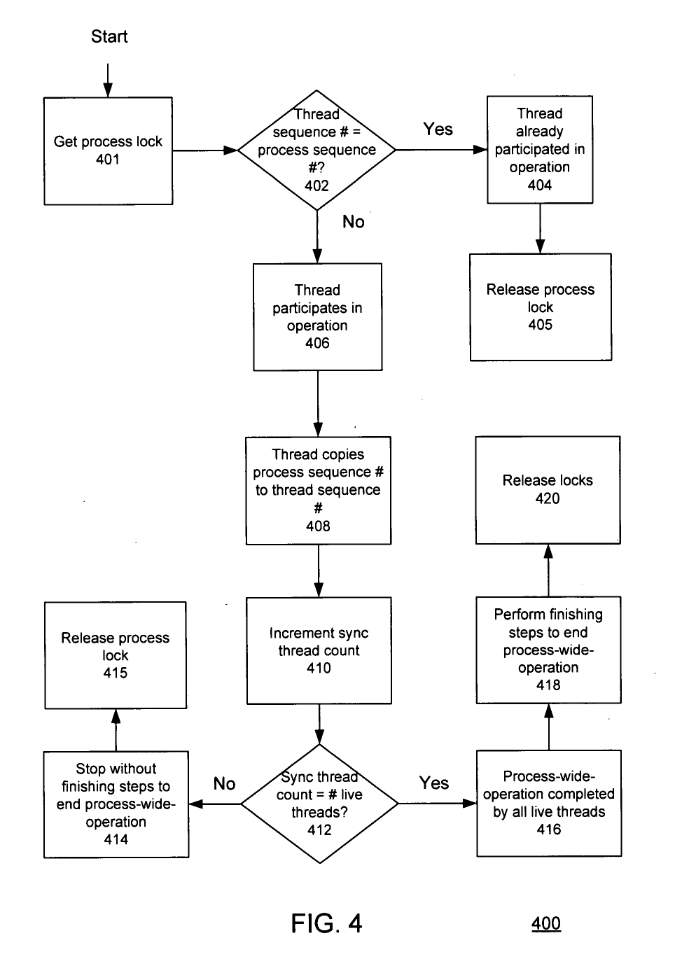

FIG. 4 is a flow chart depicting a procedure 400 performed by a target thread 108 in accordance with an embodiment of the invention. The procedure 400 may begin by the target thread obtaining the process lock (block 401). The process lock is needed to examine process fields and thread fields

The target thread may then check (block 402) to see whether the “thread sequence number” is equal to the “process sequence number”. If those sequence numbers are equal, then that means that this target thread has already performed the action for this operation (block 404). Hence, no further action need be taken by this target thread with regard to the process-wide operation. The process lock may then be released (block 405). On the other hand, if the thread sequence number is not equal to the process sequence number, then the target thread may go on to participate in the operation (block 406).

After participation is done, then the target thread may copy the process sequence number to the thread sequence number (block 408). This indicates that this thread has now participated in the operation.

The “sync thread count” is then incremented (block 410). As mentioned above, the sync thread count indicates the number of threads that have been synchronized; in other words, it indicates the number of threads that have already participated in the process-wide operation.

A check is then performed to see whether the sync thread count is equal to the current number of live threads (block 412). If the counts are not equal, then the process-wide operation is not yet complete, and hence no further action need be taken by this target thread with regard to the process-wide operation (block 414). The process lock may then be released (block 415).

On the other hand, if the counts are equal, then this indicates that the process-wide operation has now been completed by all live threads (block 416). In this case, the target thread may perform appropriate finishing steps (block 418) to end the process-wide operation. Thereafter, the target thread may release (block 420) the various locks, including the process lock and the process-wide operation lock.

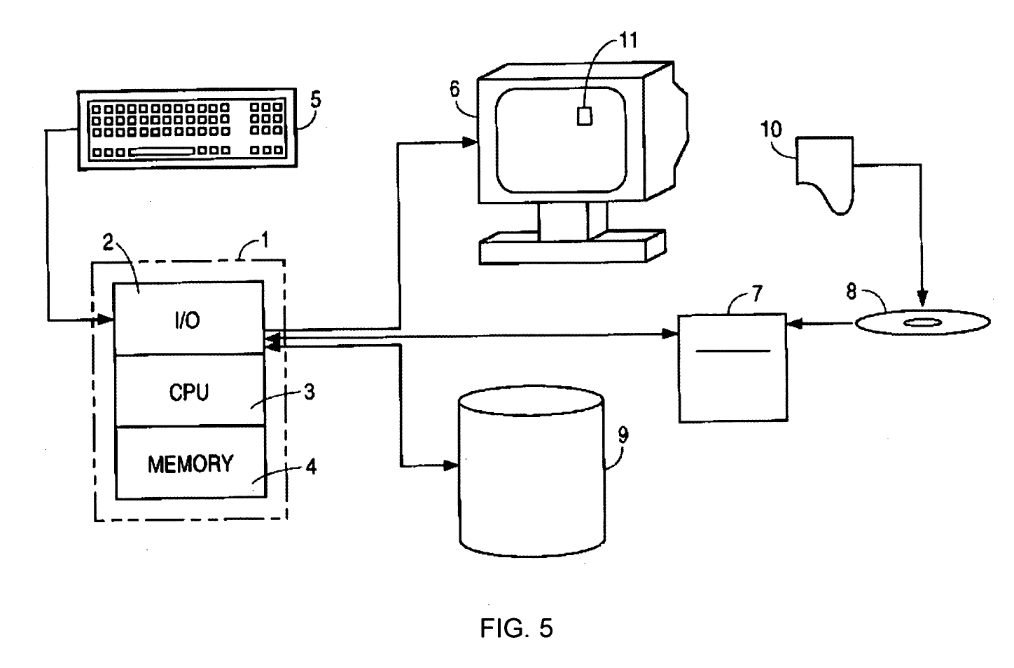

FIG. 5 illustrates a portion of an example computer system, including a CPU and conventional memory in which the present invention may be embodied. This example environment in which the present invention is used encompasses a general-purpose computer system, such as a server, a workstation or other computing system. Some of the elements of a general-purpose computer are shown in FIG. 5, wherein a computing system 1 is shown, having an Input/output (“I/O”) section 2, a microprocessor or central processing unit (“CPU”) 3, and a memory section 4. The I/O section 2 is connected to a keyboard and/or other input devices 5, a display unit and/or other output devices 6, one or more fixed storage units 9 and/or removable storage units 7. The removable storage unit 7 can read a data storage medium 8 which typically contains an operating system, application programs and other data 10. While a particular configuration is shown in FIG. 5, the scope of the present invention is not to be limited to that configuration. The present invention may be used advantageously in various computer systems, such as, for example, multiprocessor systems.

The above disclosure pertains to computer-implemented methods of efficiently, cooperatively, and concurrently performing a process-wide operation in a multi-threaded process being executed on a computer system. These computer-implemented methods result in more efficient performance of the operating system of the computer system and, hence, more efficient performance of the computer system.

As discussed above, one advancement disclosed herein relates to the process lock being cut up into small disjoint periods, rather than needing the process lock for a continuous hold for the duration of a process-wide operation. Because the number of threads in the process and the state of the threads may change while the process lock is dropped, the synchronization number scheme described above provides tracking and coordination to advantageously account for such changes.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A computer-implemented method of efficiently performing a process-wide operation in a multi-threaded process being executed on a computer system, the method comprising:
initiation of the process-wide operation by an initiator thread;
assignment of an identifying number to the process-wide operation;
participation in the process-wide operation by each target thread; and
after participation, each target thread storing a copy of the identifying number so as to avoid duplicative participation.

2. The method of claim 1, wherein the identifying number comprises a process sequence number, and wherein the copy of the process sequence number is stored in a thread sequence number for that thread.

3. The method of claim 2, further comprising incrementing the process sequence number before the assignment.

4. The method of claim 1, further comprising:
acquiring a process lock which is a spin lock before the assignment of the identifying number; and
releasing the process lock after the assignment of the identifying number, but before participation in the process-wide operation by the target threads; and
subsequently acquiring and releasing the process lock during the process-wide operation so that the process lock is held in disjointed periods over a duration of the process-wide operation.

5. The method of claim 4, further comprising:
holding a process thread list lock during traversal of the target threads of the multi-threaded process, wherein the process thread list lock prevents the thread list from changing.

6. The method of claim 1, further comprising:
concurrent participation in the process-wide operation by a plurality of threads of the process.

7. The method of claim 6, wherein finishing steps of the process-wide operation are performed by a last thread participating in the process-wide operation, regardless of whether the last thread is the initiator thread or one of the target threads.

8. The method of claim 7, wherein the last thread participating in the process-wide operation is determined by comparison of a synchronized thread count with a number of live threads.

9. The method of claim 1, wherein the process-wide operation requires synchronization among multiple threads of the process.

10. The method of claim 9, wherein the process-wide operation comprises a process-wide job control stop.

11. The method of claim 9, wherein the process-wide operation comprises a process deactivation.

12. The method of claim 9, wherein the process-wide operation comprises a process suspension.

13. A computer-implemented method of cooperatively performing a process-wide operation in a multi-threaded process being executed on a computer system, the method comprising:
acquiring a process lock which is a spin lock by an initiator thread before assignment of an identifying number;
releasing the process lock after the assignment of the identifying number, but before participation in the process-wide operation by target threads; and
subsequently acquiring and releasing the process lock during the process-wide operation so that the process lock is held in disjointed periods over a duration of the process-wide operation.

14. The method of claim 13, further comprising:
concurrent participation in the process-wide operation by a plurality of threads of the process while the non-spin-lock is being held.

15. The method of claim 14, wherein finishing steps of the process-wide operation are performed by a last thread participating in the process-wide operation, regardless of whether the last thread is the initiator thread or one of the target threads.

16. A computer-implemented method of concurrently performing a process-wide operation in a multi-threaded process being executed on a computer system so as to result in more efficient performance of the computer system, the method comprising:
concurrent participation in the process-wide operation by a plurality of threads of the process; and
performance of finishing steps of the process-wide operation by a last thread participating in the process-wide operation, regardless of whether the last thread is an initiator thread or a target thread.

17. A computer system comprising:
at least one processor configured to execute computer-readable instructions;
a memory system configured to hold computer-readable instructions and data; and
an operating system comprising computer-readable instructions, wherein the instructions are configured to initiate the process-wide operation by an initiator thread, assign an identifying number to the process-wide operation, participate in the process-wide operation by each target thread, and, after participation, store a copy of the identifying number by each target thread so as to avoid duplicative participation.

18. A computer system comprising:
at least one processor configured to execute computer-readable instructions;
a memory system configured to hold computer-readable instructions and data; and
an operating system comprising computer-readable instructions, wherein the instructions are configured to acquire a process lock which is a spin lock by an initiator thread before assignment of an identifying number, release the process lock after the assignment of the identifying number, but before participation in the process-wide operation by target threads, and subsequently acquire and release the process lock during the process-wide operation so that the process lock is held in disjointed periods over a duration of the process-wide operation.

19. A computer system comprising:
at least one processor configured to execute computer-readable instructions;
a memory system configured to hold computer-readable instructions and data; and
an operating system comprising computer-readable instructions, wherein the instructions are configured to enable concurrent participation in the process-wide operation by a plurality of threads of the process, and performance of finishing steps of the process-wide operation by a last thread participating in the process-wide operation, regardless of whether the last thread is an initiator thread or a target thread.

20. A computer-implemented method of concurrently performing a process-wide operation in a multi-threaded process being executed on a computer system so as to result in more efficient performance of the computer system, the method comprising:
acquiring a process thread list lock by an initiator thread before participation in the process-wide operation by target threads, wherein the process thread list lock is a non-spin lock which prevents a thread list from changing;
holding the process thread list lock while each of the target threads is tranversed by the initiator thread; and
releasing the process thread list lock at a conclusion of the traversal whether the process wide operation is complete or not.

21. The method of claim 20, further comprising holding a process lock for each target thread to check its state and for the initiator thread to determine if the process wide operation is complete.
